(19) United States
(12) Patent Application Publication
(10) Pub. No.: US 2023/0227113 A1
(43) Pub. Date: Jul. 20, 2023

(54) Modular Hydraulic Cab And Frame System With A Universal Junction

(71) Applicant: ZOOMLION Heavy Industry NA, Inc., Yorkville, WI (US)

(72) Inventors: Mark McKinley, Wauwatosa, WI (US); Steven Melotik, Kenosha, WI (US)

(21) Appl. No.: 17/577,700

(22) Filed: Jan. 18, 2022

(51) Int. Cl. B62D 33/06

(52) U.S. Cl. CPC B62D 33/06

(57) ABSTRACT

A universal junction preferably includes at least one hydraulic connector block, a plurality of hydraulic pressure sensors, a plurality of hydraulic quick disconnect fittings and a plurality of hydraulic fittings and a retention bracket. A first hydraulic connector block includes the plurality of hydraulic quick disconnects fittings, the plurality of hydraulic fittings and the plurality of hydraulic sensors for receiving hydraulic lines from two joysticks. A second hydraulic connector block preferably includes three hydraulic quick disconnect fittings retained in a cab side and three hydraulic fittings retained in a frame side. The second hydraulic connector block also includes two hydraulic pressure sensors and two hydraulic valves and a feed through port for receiving hydraulic lines from two foot treadles. An electric bulkhead is formed through a floor or wall of the modular cable to receive an electric cable from the modular frame.

### BACKGROUND OF THE INVENTION

### 1. Field of the Invention

The present invention relates generally to heavy equipment and more specifically to a modular hydraulic cab and frame system with a universal junction, which allows hydraulic lines and electrical lines between the modular hydraulic cab and frame system to be quickly detached.

### 2. Discussion of the Prior Art

A hydraulic modular cab system divides a piece of equipment into a hydraulic cab module and a hydraulic frame module. The hydraulic cab module can be replaced or exchanged with the same or different hydraulic cab module. The hydraulic cab and frame modules are mechanically connected to each other with a small number of fasteners. The hydraulic cab includes hydraulic operated joysticks and foot treadles, which must be supplied with hydraulic fluid to operate a tool located on the hydraulic frame module. To facilitate the quick replacement or exchange of the hydraulic cab module, the electrical and hydraulic lines must also be quickly detachable. It is also advantageous for the universal junction to provide diagnostic access to the hydraulic and electrical lines. Additionally, the universal junction could provide access to refill the hydraulic or coolant circuits and recharge the A/C circuit. It appears that the prior art does not teach or suggest a universal junction for a modular hydraulic cab and frame system.

Accordingly, there is clearly felt need in the art for a modular hydraulic cab and frame system with a universal junction, which allows hydraulic lines and electrical lines between the modular hydraulic cab and the modular hydraulic frame to be quickly detached; provide a diagnostic test point between the cab hydraulic module and hydraulic frame module; and allow access to refill the hydraulic lines.

### SUMMARY OF THE INVENTION

The present invention provides a modular hydraulic cab and frame system with a universal junction, which allows hydraulic and electrical lines between the modular hydraulic cab and frame system to be quickly detached. The universal junction preferably includes at least one hydraulic connector block, a plurality of hydraulic pressure sensors, a plurality of hydraulic quick disconnect fittings and a plurality of hydraulic fittings and a retention bracket. A first hydraulic connector block includes a plurality of feed through ports. One of the plurality of hydraulic disconnect fittings is threaded into a cab end of one of the plurality feed through ports and one of a plurality of hydraulic fittings is threaded into an opposing frame end of the feed through port. One of the plurality of hydraulic sensors is threaded into the feed through port. The hydraulic pressure sensor measures the pressure of the hydraulic fluid in the feed through port. The pressure is outputted to any suitable electronic device. The first hydraulic connector block is preferably used to monitor the hydraulic lines from first and second hydraulic joysticks.

A second hydraulic connector block preferably includes a return feed through port, a left tool port and a right tool port. Three hydraulic quick disconnect fittings are threaded into the three feed ports on a cab side of the second hydraulic connector block and three hydraulic fittings are threaded into the feed ports on an opposing frame side of the second hydraulic connector block. A left tool hydraulic pressure sensor is threaded into the left tool port and a right tool hydraulic pressure sensor is threaded into the right tool port. A left hydraulic valve controls flow through the left tool port and a right hydraulic valve controls flow through the right port.

The retention bracket is attached to the modular frame. The first and second hydraulic connector blocks are attached to the retention bracket. A first fitting retainer is preferably attached to an end of the retention bracket. A plurality first double ended fittings are attached to the first fitting retainer. Each first double ended fitting includes a hydraulic quick release end and a hydraulic fitting end. A second fitting retainer is preferably attached to a bottom of the retainer bracket. A plurality of second double ended fittings are attached to the second fitting retainer. Each second double ended fitting includes a hydraulic quick release end and a hydraulic fitting end. An electrical cable includes at least one connector plug. The electrical cable is preferably retained by the retention bracket and a freely moving end. The plurality of hydraulic quick disconnect fittings in the universal junction prevent flow from the modular hydraulic frame and the plurality of cab hydraulic quick disconnect fittings prevent flow from the modular cab frame.

The modular hydraulic cab includes a first hydraulic joystick, a second hydraulic joystick, a hydraulic foot control and electrically operated equipment. A plurality of cab hydraulic lines extend through a wall of the modular cab from the first hydraulic joystick and the second hydraulic joystick. The plurality of cab hydraulic lines are terminated with a plurality of hydraulic quick disconnect fittings. An electrical bulkhead is preferably located in a floor or side wall of the modular hydraulic cab. The electrical bulkhead includes at least one electrical socket. The at least one connector plug is plugged into the at least one electrical socket in the electrical bulkhead. A plurality of frame hydraulic lines are threaded on to the frame side of the universal junction.

When a modular hydraulic cab is to be replaced for any reason. The plurality of cab hydraulic lines are disconnected from the universal junction and the electrical cable from the electrical bulkhead. Coolant lines and A/C lines would also include quick disconnect coupling between the modular cab and modular frame. The modular cab is unbolted from the frame and taken away. A replacement modular cab is bolted to the modular frame. The electrical cable is plugged into the electrical bulkhead connector. The cab hydraulic lines are inserted into the plurality of hydraulic quick disconnect fittings in the universal junction. Finally, the A/C lines and coolant lines are quickly connected to their respective quick disconnect fittings. The replacement modular cab is now able to operate the modular frame and the tool on the modular frame, such as a shovel.

Diagnostic readings of the electrical and hydraulic lines of the modular cab or modular frame can be achieved by connecting the modular cab or frame to a portable diagnostic device. Further, vehicle diagnostic readings can be achieved during operation by inserting the portable diagnostic device between the modular and frame in series when they are combined for standard operation.

Accordingly, it is an object of the present invention to provide a modular hydraulic cab and frame system with a universal junction, which allows hydraulic lines and electrical lines between the modular hydraulic cab and the modular hydraulic frame to be quickly detached.

It is a further object of the present invention to provide a modular hydraulic cab and frame system with a universal junction, which provide a diagnostic test point between the cab hydraulic module and hydraulic frame module.

Finally, it is another object of the present invention to provide a modular hydraulic cab and frame system with a universal junction, which allows access to refill the hydraulic or coolant circuits and recharge the A/C circuit.

These and additional objects, advantages, features and benefits of the present invention will become apparent from the following specification.

### BRIEF DESCRIPTION OF THE DRAWINGS

FIG. 1 is a perspective view of a plurality of hydraulic lines of a modular cab connected to a universal junction, the universal junction is mounted to a portion of a modular frame in accordance with the present invention.

FIG. 2 is an exploded side view of a modular cab detached from a portion of a modular frame and a universal junction mounted to the portion of the modular frame in accordance with the present invention.

FIG. 3 is a top view of a modular cab with a universal junction mounted to the portion of the modular frame and the modular cab mounted to the modular frame in accordance with the present invention.

FIG. 4 is a bottom perspective view of a modular cab with a plurality of hydraulic lines connected to a universal junction in accordance with the present invention.

FIG. 5 is a top perspective view of a modular cab floor and a portion of a modular frame with a plurality of hydraulic lines for two joysticks extending through the modular cab floor and a universal junction attached to the floor of the portion of the modular frame and a plurality of hydraulic lines attached to the universal junction in accordance with the present invention.

FIG. 6 is a top view of a universal junction in accordance with the present invention.

FIG. 7 is an end view of a cab side of a universal junction in accordance with the present invention.

FIG. 8 is a cross sectional view of a hydraulic flow through port of a universal junction illustrating a hydraulic sensor in accordance with the present invention.

FIG. 9 is a cross sectional view of a hydraulic flow through port of a universal junction illustrating a hydraulic valve and a hydraulic sensor in accordance with the present invention.

### DETAILED DESCRIPTION OF THE PREFERRED EMBODIMENTS

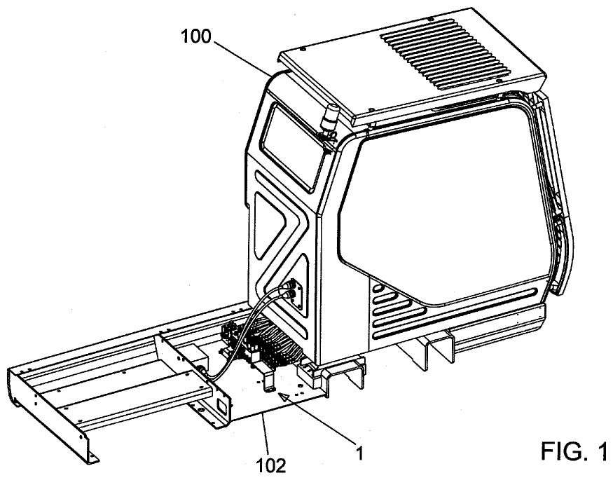

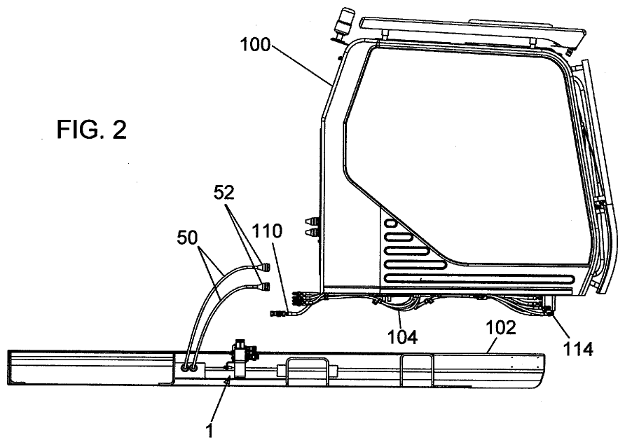

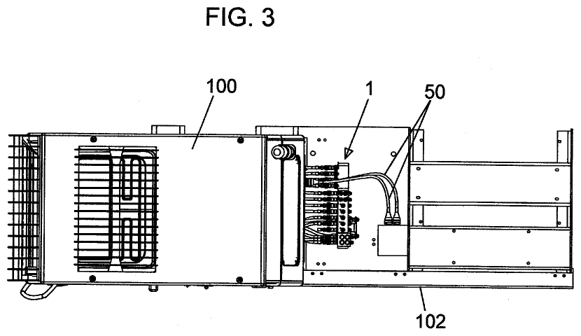

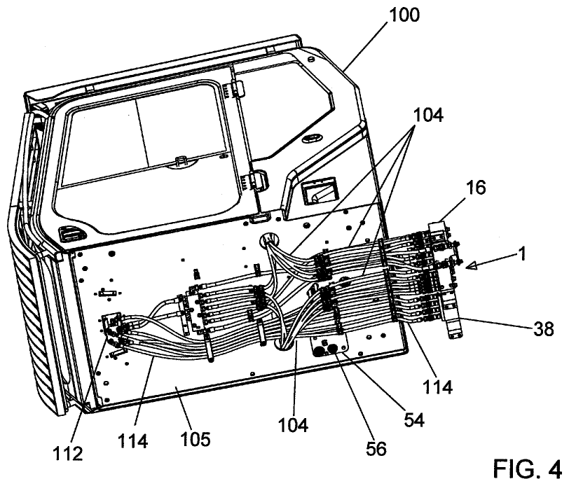

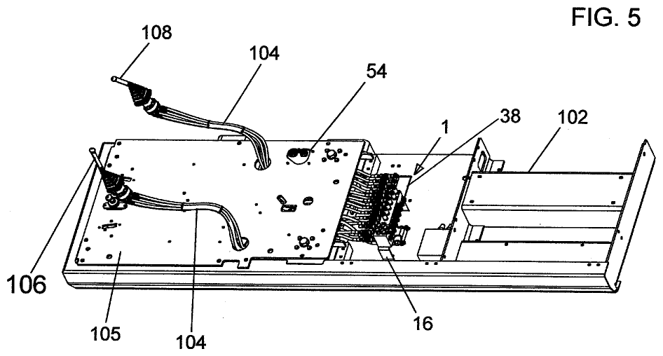

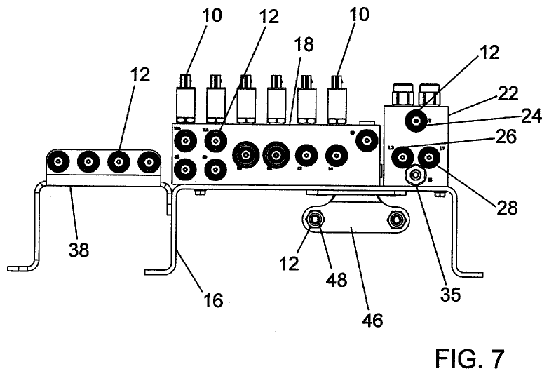

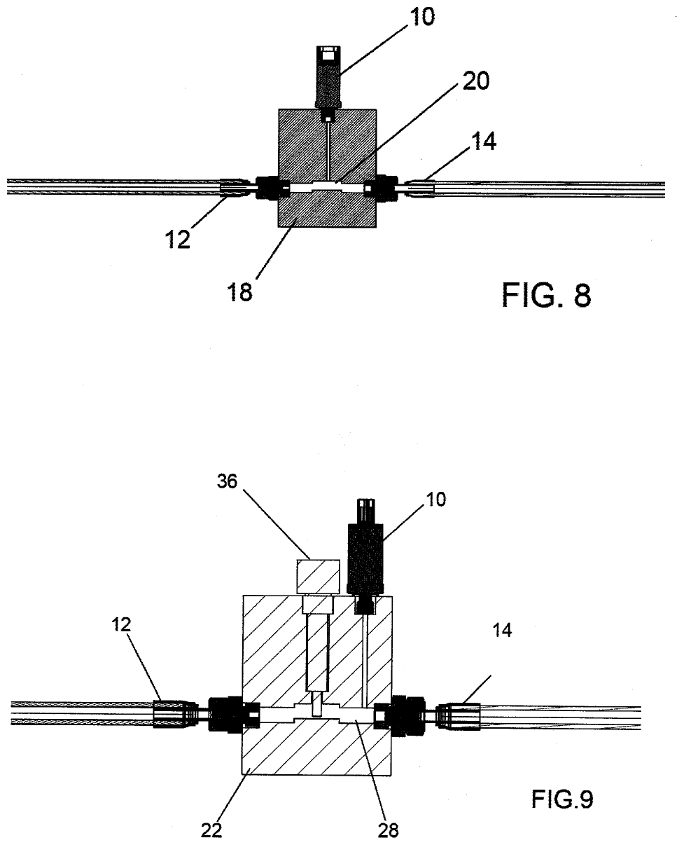

With reference now to the drawings, and particularly to FIG. 1, there is shown a perspective view of a modular cab 100 mounted to a portion of a modular frame 102. A universal junction 1 is mounted to the portion of the modular frame 102. A plurality of cab hydraulic lines extend from the modular cab 100. The plurality of cab hydraulic lines are retained in the universal junction 1. With reference to FIGS. 2-8, the universal junction 1 preferably includes at least one hydraulic connector block, a plurality of hydraulic pressure sensors 10, a plurality of hydraulic quick disconnect fittings 12, a plurality of hydraulic fittings 14 and a retention bracket 16. A first hydraulic connector block 18 includes a plurality of hydraulic feed through ports 20. One of the plurality of hydraulic quick disconnect fittings 12 is threaded into a cab end of the feed through port 20 and one of a plurality of hydraulic fittings 14 is threaded into an opposing frame end of the feed through port. One of the plurality of hydraulic sensors 10 is threaded into the hydraulic feed through port. The hydraulic pressure sensor 10 measures the pressure of the hydraulic fluid in the feed through port 20. The hydraulic pressure from the hydraulic sensor 10 is outputted to any suitable electronic device. With reference to FIG. 5, the first hydraulic connector block 18 is preferably used to monitor the joystick hydraulic lines 104 from first and second hydraulic joysticks 106, 108. The first hydraulic connector block 18 is preferably secured to the retention bracket 16 with fasteners or any suitable mounting device.

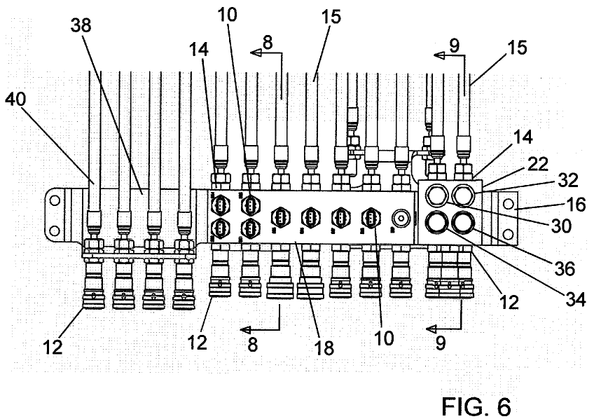

With reference to FIGS. 6, 7 and 9, a second hydraulic connector block 22 preferably includes a return hydraulic feed through port 24, a left tool hydraulic control port 26 and a right tool hydraulic control port 28. Three hydraulic quick disconnect fittings 12 are threaded into the three hydraulic ports 24, 26, 28 on a cab side of the second hydraulic connector block 22 and three hydraulic fittings 14 are threaded into an opposing frame side of the second hydraulic connector block 22. A left tool pressure sensor 30 is tapped into the left tool hydraulic port 26 and a right tool pressure sensor 32 is tapped into the right tool hydraulic port 28. A left hydraulic valve 34 allows flow through the left tool hydraulic control port 26 and a right hydraulic valve 36 allows flow through the right tool control hydraulic port 28. The left and right hydraulic valves 34, 36 are preferably actuated by a hydraulic pilot line 35. Hydraulic fluid supplied to the hydraulic pilot line 35 is preferably controlled with a normally closed solenoid. The normally closed solenoid must be actuated to lock fluid from flowing to the hydraulic pilot line 35. The second hydraulic connector block 22 is preferably secured to the retention bracket 16 with fasteners or any suitable mounting device. The retention bracket 16 is preferably attached to the hydraulic frame module with fasteners or any suitable attached device. The first and second hydraulic blocks may be combined into a single hydraulic block.

A first fitting retainer 38 is preferably attached to an end of the retention bracket 16. A plurality of first double ended fittings 40 are attached to the first fitting retainer 38. Each first double ended fitting 40 includes a hydraulic quick release end and an opposing hydraulic fitting end. Some of the plurality of hydraulic quick disconnect fittings 12 are attached to the hydraulic quick release end and a plurality of hydraulic hoses (not shown) are attached to the hydraulic fitting end. A second fitting retainer 46 is preferably attached to a bottom of the retainer bracket 16. A plurality of second double ended fittings 48 are attached to the second fitting retainer 46. Each second double ended fitting 48 includes a hydraulic quick release end and an opposing hydraulic fitting end. Some of the plurality of hydraulic quick disconnect fittings 12 are attached to the hydraulic quick release end of second double ended fitting 48 and a plurality of hydraulic hoses (not shown) are attached to the hydraulic fitting end. However, the retention bracket 16, the first fitting retainer 38 and the second fitting retainer 46 may be fabricated from single piece of material. An electrical cable 50 includes at least one connector plug 52. The electrical cable 50 is preferably retained by the retention bracket 16 with a free moving end. The plurality of hydraulic quick disconnect fittings 12 of the universal junction 1 prevent flow from the portion of modular frame 102 hydraulic system, when the plurality of cab hydraulic lines 104, 114 are disconnected from the plurality of quick disconnect fittings 12.

The modular cab 100 includes the first hydraulic joy stick 106, a second hydraulic joy stick 108, a hydraulic foot control 112 and electrically operated equipment. A plurality of joystick hydraulic lines 104 extend through a floor 105 of the modular cab from the first hydraulic joy stick 106 and the second hydraulic joy stick 108. A plurality of foot hydraulic lines 114 extend from a bottom of the hydraulic foot control 112. The plurality of cab hydraulic lines 104, 114 are terminated with a plurality of hydraulic quick disconnect fittings 110. The plurality of cab hydraulic lines 104, 114 prevent the flow of hydraulic fluid from the modular cab hydraulic system, when the plurality of cab hydraulic lines 104, 114 are disconnected from the plurality of quick disconnect fittings 12. An electrical bulkhead 54 is preferably located in the floor 105 or side wall of the modular cab 100. The electrical bulkhead 54 includes at least one electrical socket 56. The at least one connector plug 52 is plugged into the at least one electrical socket 56 in the electrical bulkhead 54. A plurality of frame hydraulic lines 15 are threaded on to the frame side of the universal junction 1.

When a modular cab 100 is to be replaced for any reason. The plurality of cab hydraulic lines 104, 114 are disconnected from the universal junction 1 and the electrical cable 50 from the electrical bulkhead 54. Coolant lines and A/C lines also include quick disconnect coupling between the modular cab 100 and modular hydraulic frame 102. The modular cab 100 is unbolted from the frame and taken away. A replacement cab is bolted to the modular frame 102. The electrical cable 50 is plugged into the electrical bulkhead connector 54. The cab hydraulic lines 104, 114 are inserted into the plurality of hydraulic quick disconnect fittings 12. Finally, the A/C lines and coolant lines are quick connected to their respective quick disconnect fittings. The replacement hydraulic cab is now able to operate the modular frame 102 and the tool on the modular frame 102, such as a shovel.

Diagnostic readings of the electrical and hydraulic circuits of the modular cab 100 or modular frame 102 can be achieved by connecting the modular cab 100 or frame 102 to a portable diagnostic device. Further, vehicle diagnostic readings can be achieved during operation by inserting the portable diagnostic device between the modular cab 100 and the modular frame 102 in series when they are combined for standard vehicle operation.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

I claim:

1. A universal junction for connecting a modular cab with a modular frame, said universal junction is retained on the modular frame, the modular cab includes a plurality of cab hydraulic lines, the plurality of cab hydraulic lines are terminated with cab hydraulic quick disconnect fittings, a plurality of frame hydraulic lines extend from the modular frame, comprising:
at least one hydraulic connector block includes a plurality of feed through ports;
a plurality of hydraulic quick disconnect fittings are engaged with one end of said plurality of feed through ports, wherein the plurality of cab hydraulic quick disconnect fittings are adapted for connection to said plurality of quick disconnect fittings;
a plurality of hydraulic fittings are engaged with an opposing end of said plurality of feed through ports, wherein the plurality frame hydraulic lines are adapted for connection to said plurality of hydraulic fittings;
a plurality of pressure sensors are tapped into said plurality of feed through ports, wherein said plurality of pressure sensors measure a pressure in said plurality of feed through ports.

2. The universal junction for connecting a modular cab with a modular frame of claim 1, further comprising:
a mounting bracket for attachment to the modular frame, said at least one hydraulic connector block is attached to said mounting bracket.

3. The universal junction for connecting a modular cab with a modular frame of claim 1, further comprising:
a fitting retainer extends from said mounting bracket, a plurality of double ended fittings are retained on said fitting retainer, each one of said double ended fittings includes a hydraulic quick release end and a hydraulic fitting end.

4. A universal junction for connecting a modular cab with a modular frame, said universal junction is retained on the modular frame, the modular cab includes a plurality of cab hydraulic lines, the plurality of cab hydraulic lines are terminated with cab hydraulic quick disconnect fittings, a plurality of frame hydraulic lines extend from the modular frame, comprising:
at least one hydraulic connector block includes a plurality of feed through ports;
a plurality of hydraulic quick disconnect fittings are engaged with one end of said plurality of feed through ports, wherein the plurality of cab hydraulic quick disconnect fittings are adapted for connection to said plurality of quick disconnect fittings;
a plurality of hydraulic fittings are engaged with an opposing end of said plurality of feed through ports, wherein the plurality frame hydraulic lines are adapted for connection to said plurality of hydraulic fittings;
a plurality of pressure sensors are tapped into said plurality of feed through ports, wherein said plurality of pressure sensors measure a pressure in said plurality of feed through ports; and
at least one hydraulic valve is retained in at least one of said plurality of feed through ports.

5. The universal junction for connecting a modular cab with a modular frame of claim 4, further comprising:
a mounting bracket for attachment to the modular frame, said at least one hydraulic connector block is attached to said mounting bracket.

6. The universal junction for connecting a modular cab with a modular frame of claim 4, further comprising:
a fitting retainer extends from said mounting bracket, a plurality of double ended fittings are retained on said fitting retainer, each one of said double ended fittings includes a hydraulic quick release end and a hydraulic fitting end.

7. A universal junction for electrically connecting a modular cab with a modular frame, comprising:
a frame electrical line extending from the modular frame, said electrical cable including at least one electrical plug; and
an electrical bulkhead is retained on an outside surface of the modular cab, said electrical bulkhead includes at least one electrical socket, wherein said at least one electrical plug is adapted for electrical engagement with said at least one electrical socket.

8. The universal junction for connecting a modular cab with a modular frame of claim 7, further comprising:
a universal junction includes a selectively detachable hydraulic connection between the modular cab and the modular frame, said frame electrical cable is retained in said universal junction, said at least one electrical plug moves freely relative to said universal junction.
